(19) United States
(12) Patent Application Publication
(10) Pub. No.: US 2009/0071795 A1
(43) Pub. Date: Mar. 19, 2009

(54) Coin-guiding plate for a coin counter

(76) Inventor: Shu-Chuan Chung, Kaohsiung Hsien (TW)

Correspondence Address: MCCRACKEN & FRANK LLP, 311 S. WACKER DRIVE, SUITE 2500, CHICAGO, IL, 60606, US

(21) Appl. No.: 12/074,474

(22) Filed: Mar. 4, 2008

(30) Foreign Application Priority Data
Sep. 19, 2007 (TW) 096215750

(51) Int. Cl. G07F 1/04

(52) U.S. Cl. 194/346

(57) ABSTRACT

A coin-guiding plate includes: a fixing segment; a guiding segment extending from the fixing segment, and having opposite first and second sides, a second guiding portion being recessed relative to a first guiding portion at the second side, the first guiding portion having a pointed tip opposite to the second guiding portion; and a blocking member formed at a junction of the fixing segment and the second guiding portion. The fixing segment is adapted to be fixed to a housing such that the guiding segment extends into a groove of a rotary plate that receives coins, and such that the first and second sides respectively face toward and away from a central plate portion of the rotary plate. The blocking member is adapted to form a gap with a groove bottom having a size for allowing at most one coin therethrough when the fixing segment is fixed to the housing.

### CROSS-REFERENCE TO RELATED APPLICATION

This application claims priority of Taiwanese Application No. 096215750, filed on Sep. 19, 2007.

### BACKGROUND OF THE INVENTION

1. Field of the Invention

The invention relates to a coin counter, more particularly to a coin-guiding plate for a coin counter.

2. Description of the Related Art

Referring to FIG. 1, a conventional coin counter 1 includes a stand 11, a housing 12, a rotary plate assembly 13, a motor 14, first and second push members 15, 16, a coin-guiding plate 17, and a counting unit 18.

The housing 12 is mounted on the stand 11, and includes a coin exit 121.

The rotary plate assembly 13 includes a plate body 131 disposed rotatably in the housing 12, and formed with a central plate portion 136 and an annular groove 132. The rotary plate assembly 13 further includes a plurality of spaced apart protrusion sets 133 disposed in the annular groove 132. Each pair of adjacent ones of the protrusion sets 133 defines a region 134 therebetween. Therefore, the annular groove 132 is divided into a plurality of the regions 134. Each of the protrusion sets 133 includes two spaced apart protrusions 135.

The motor 14 is coupled to a center of the plate body 131 of the rotary plate assembly 13 for driving rotation of the plate body 131 in a counterclockwise direction shown by arrow (A) in FIG. 1.

The first push member 15 is made from a pliable material, e.g., rubber, and includes a first fixing portion 151 disposed on the housing 12, and a first pushing portion 152 extending from the first fixing portion 151 and defining a distance slightly greater than a thickness of a coin (not shown) with a groove bottom of the annular groove 132.

The second push member 16 is made from copper, and includes a second fixing portion 161 disposed on the housing 12, and a second pushing portion 162 extending from the second fixing portion 161 toward the coin exit 121 of the housing 12 and defining a distance slightly greater than the thickness of the coin with the groove bottom of the annular groove 132.

The coin-guiding plate 17 includes a fixing segment 171 fixed to the housing 12, and a guiding segment 172 extending from the fixing segment 171 toward the first pushing portion 152 of the first push member 15. The guiding segment 172 has a curved surface 173 disposed in slidable contact with a periphery of the central plate portion 136 of the rotary plate 131, and a guiding surface 174 disposed proximate to the second pushing portion 162 of the second push member 16.

The counting unit 18 is used to count the number of coins ejected out of the housing 12 via the coin exit 121. Since the configuration of the counting unit 18 is known in the art, further details of the same are omitted herein for the sake of brevity.

During operation of the conventional coin counter 1, where a large amount of coins (not shown) is supplied to the housing 12, the motor 14 drives the plate body 131 of the rotary plate assembly 13 to rotate in the counterclockwise direction (A). The resulting rotation of the plate body 131 functions to eject the coins held in the regions 134 out through the coin exit 121. The first and second pushing portions 152, 162 of the first and second push members 15, 16 ensure that the coins are not stacked in each of the regions 134 (i.e., to ensure that only one coin is placed in each of the regions 134) before being ejected out of the housing 12 by the plate body 13. The stacked coins that are blocked by the second pushing portion 162 of the second push member 16 slide along the guiding surface 174 of the coin-guiding plate 17 in a downward direction toward the bottom of FIG. 1. While the coins are ejected, the counting unit 18 counts the number of ejections of the coins.

The conventional coin counter 1 has the following shortcomings:

1. Since both of the first and second pushing portions 152, 162 of the first and second push members 15, 16 are flexible, when there are too many coins in the housing 12 so that the first and second pushing portions 152, 162 are pushed away from the annular groove 132 in the plate body 131, the first and second pushing portions 152, 162 may not be able to spring back in time to ensure that the coins are not stacked in each of the regions 134. This contributes to the possibility of counting errors with the conventional coin counter 1. In addition, the excess number of coins trying to exit via the coin exit 121 may even damage the coin exit 121, thereby reducing lifetime of the conventional coin counter 1.

2. Since the first push member 15 is made of a pliable material and the second push member 16 is made from copper, the first and second push members 15, 16 are easily deformed, or even broken, particularly when many coins are present in the housing 12. Deformation of the first and second push members 15, 16 may be such that the first and second push members 15, 16 are unable to perform their function of preventing the stacking of coins in the regions 134 defined by the rotary plate assembly 13. If this occurs, more than one coin may be ejected out of the housing 12 each time, thereby resulting in counting errors. In addition, since a user may not be immediately aware of the deformation or breaking of the first and second push members 15, 16, the deformed or broken first or second push member 15, 16 may possibly result in jamming of the coins at the coin exit 121, which eventually leads to damage to the coin exit 121.

### SUMMARY OF THE INVENTION

Therefore, an object of the present invention is to provide a coin-guiding plate that is adapted for use in a coin counter and that steadily prevents stacking of coins prior to exiting the coin counter.

According to the present invention, there is provided a coin-guiding plate adapted for use in a coin counter that includes a housing provided with a coin exit member, and a rotary plate mounted rotatably in the housing and formed with a central plate portion and a groove having a groove bottom and surrounding the central plate portion for moving coins received in the groove in a first direction. The coin-guiding plate includes a fixing segment, a guiding segment and a blocking member. The guiding segment extends from the fixing segment in a second direction opposite to the first direction. The guiding segment has first and second sides opposite to each other in a third direction, and includes a first guiding portion and a second guiding portion connected between the first guiding portion and the fixing segment. The second guiding portion is recessed relative to the first guiding portion at the second side of the guiding segment so as to form a step at a junction of the first and second guiding portions. The first guiding portion has a pointed tip opposite to the second guiding portion. The blocking member is formed at a junction of the fixing segment and the second guiding portion.

The fixing segment is adapted to be fixed to the housing of the coin counter adjacent to the coin exit member such that the guiding segment extends into the groove of the rotary plate, and such that the first and second sides of the guiding segment respectively face toward and away from the central plate portion of the rotary plate. The blocking member is adapted to form a gap with the groove bottom of the groove when the fixing segment is fixed to the housing of the coin counter. The gap has a size greater than a thickness of a coin and smaller than a combined thickness of two coins so as to allow at most one coin to pass through the gap.

The advantage of the present invention resides in that the step formed at the junction of the first and second guiding portions of the guiding segment is adapted to result in separation of two stacked coins upon traveling over the step. In addition, the gap formed between the blocking member and the groove bottom of the groove when the fixing segment is fixed to the housing of the coin counter ensures that at most one coin passes through the gap each time. Therefore, the coin-guiding plate when incorporated into the coin counter not only ensure precise counting of coins, but also prevents stacked coins from damaging the coin exit member of the housing of the coin counter, thereby extending the lifetime of the coin counter.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic front view of a conventional coin counter;

FIG. 2 is a schematic front view of a coin counter incorporating the preferred embodiment of a coin-guiding plate according to the present invention;

FIG. 3 is an enlarged fragmentary perspective view of the preferred embodiment;

FIG. 4 is a perspective view of the preferred embodiment;

FIG. 5 is a fragmentary schematic view of the coin counter, illustrating a first situation of two stacked coins being separated by the preferred embodiment of the coin-guiding plate;

FIG. 6 is a fragmentary sectional view of the coin counter, illustrating the first situation of two stacked coins being separated by the preferred embodiment of the coin-guiding plate;

FIG. 7 is a fragmentary schematic view of the coin counter, illustrating a second situation of two stacked coins being separated by the preferred embodiment of the coin-guiding plate; and

FIG. 8 is a fragmentary sectional view of the coin counter, illustrating the second situation of two stacked coins being separated by the preferred embodiment of the coin-guiding plate.

### DETAILED DESCRIPTION OF THE PREFERRED EMBODIMENT

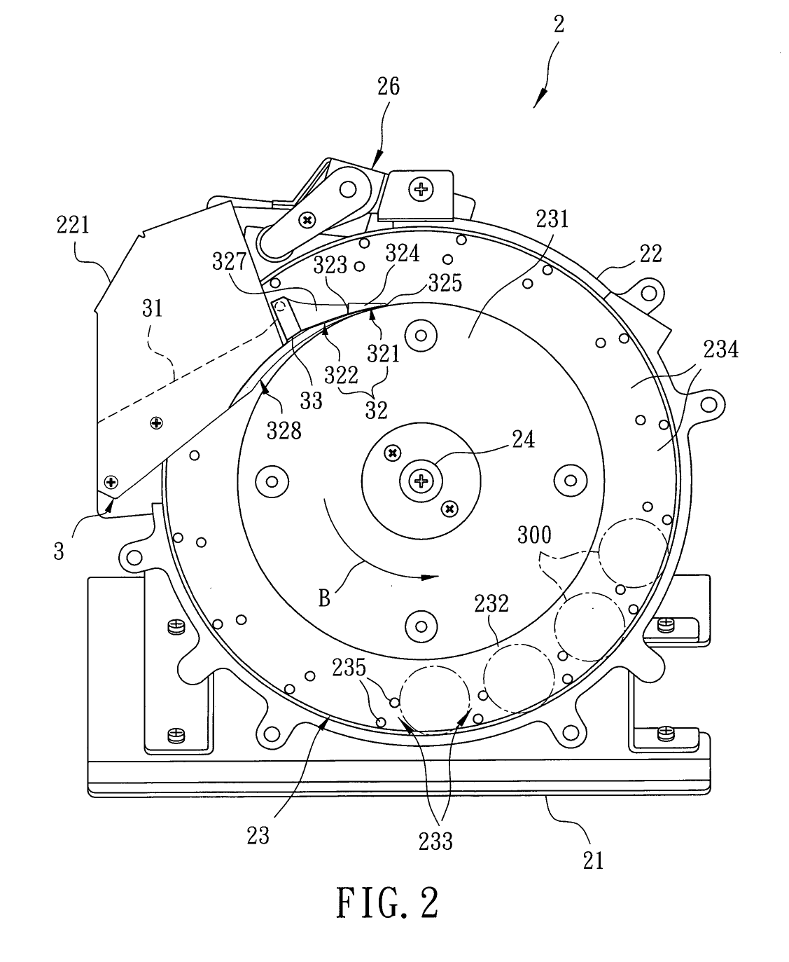

As shown in FIG. 2, the preferred embodiment of a coin-guiding plate 3 according to the present invention is adapted for use in a coin counter 2 that includes a stand 21, a housing 22, a rotary plate 23, a driving member 24, and a coin-counting unit 26. The housing 22 is fixed to the stand 21, and is provided with a coin exit member 221. The rotary plate 23 is mounted rotatably in the housing 22, and is formed with a central plate portion 231 and a groove 232 having a groove bottom and surrounding the central plate portion 231. The rotary plate 23 is driven to rotate by the driving member 24, e.g., a motor, for moving coins 300 received in the groove 232 in a first direction (B). The rotary plate 23 is provided with a plurality of spaced apart protrusion sets 233 disposed in the groove 232. Each pair of adjacent ones of the protrusion sets 233 defines a region 234 therebetween. Therefore, the groove 232 is divided into a plurality of the regions 234. Each of the protrusion sets 233 includes two spaced apart protrusions 235. The coin-counting unit 26 is disposed proximate to the coin exit member 221 of the housing 22 for counting the coins 300 exiting the housing 22 via the coin exit member 221.

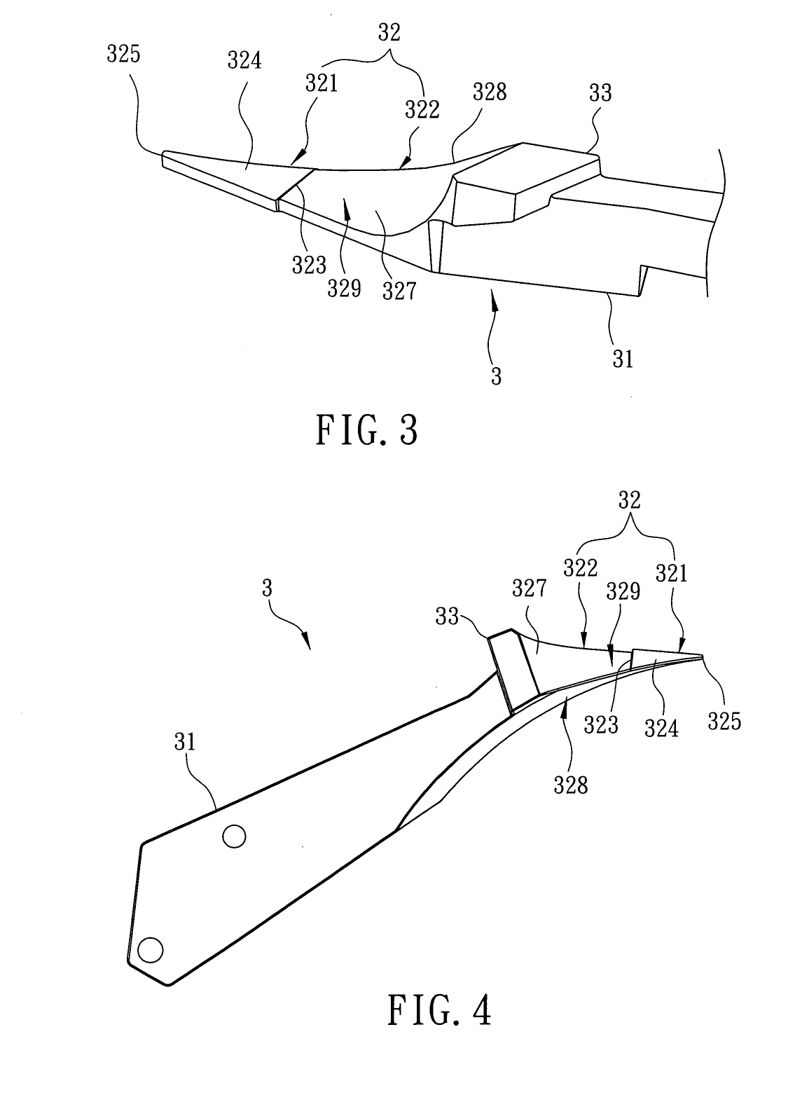

Referring to FIG. 2, FIG. 3 and FIG. 4, the coin-guiding plate 3 includes a fixing segment 31, a guiding segment 32, and a blocking member 33. The guiding segment 32 extends from the fixing segment 31 in a second direction opposite to the first direction (B). The guiding segment 32 has first and second sides 328, 329 opposite to each other in a third direction, and includes a first guiding portion 321 and a second guiding portion 322 connected between the first guiding portion 321 and the fixing segment 31. The second guiding portion 322 is recessed relative to the first guiding portion 321 at the second side 329 of the guiding segment 32 so as to form a step 323 at a junction of the first and second guiding portions 321, 322. The first guiding portion 321 has a pointed tip 325 opposite to the second guiding portion 322.

As best shown in FIG. 2, the fixing segment 31 is adapted to be fixed to the housing 22 of the coin counter 2 adjacent to the coin exit member 221 such that the guiding segment 32 extends into the groove 232 of the rotary plate 23, and such that the first and second sides 328, 329 of the guiding segment 32 respectively face toward and away from the central plate portion 231 of the rotary plate 23. In this embodiment, the first guiding portion 31 further has a first inclined surface 324 that extends from the pointed tip 325 to the junction of the first and second guiding portions 321, 322 at the second side 329 of the guiding segment 32, and that inclines toward an axis of the rotary plate 23 when the fixing segment 31 is fixed to the housing 22 of the coin counter 2.

The blocking member 33 is formed at a junction of the fixing segment 31 and the second guiding portion 322. The blocking member 33 is adapted to form a gap with the groove bottom of the groove 232 when the fixing segment 31 is fixed to the housing 22 of the coin counter 2. The gap has a size greater than a thickness of the coin 300 and smaller than a combined thickness of two coins 300 so as to allow at most one coin 300 to pass through the gap.

In this embodiment, the first side 328 of the guiding segment 32 is a concave side, and is shaped to correspond to the central plate portion 231 of the rotary plate 23. In addition, the second guiding portion 322 further has a second inclined surface 327 that extends from the junction of the first and second guiding portions 321, 322 to the blocking member 33, and that inclines toward the axis of the rotary plate 23 when the fixing segment 31 is fixed to the housing 22 of the coin counter 2. In this embodiment, the second inclined surface 327 is a curved surface. Moreover, the coin-guiding plate 3 is an integrally formed piece made of rigid metal. In particular, the coin-guiding plate 3 is made from steel.

When a plurality of coins 300 are disposed in the housing 22 of the coin counter 2, where at most one coin 300 is received in each of the regions 234 (as illustrated by dashed lines in FIG. 2), as the rotary plate 23 is driven to rotate in the first direction (B) by the driving member 24, the coins 300 received in the regions 234 are moved in the first direction (B) toward the coin exit member 221 of the housing 22.

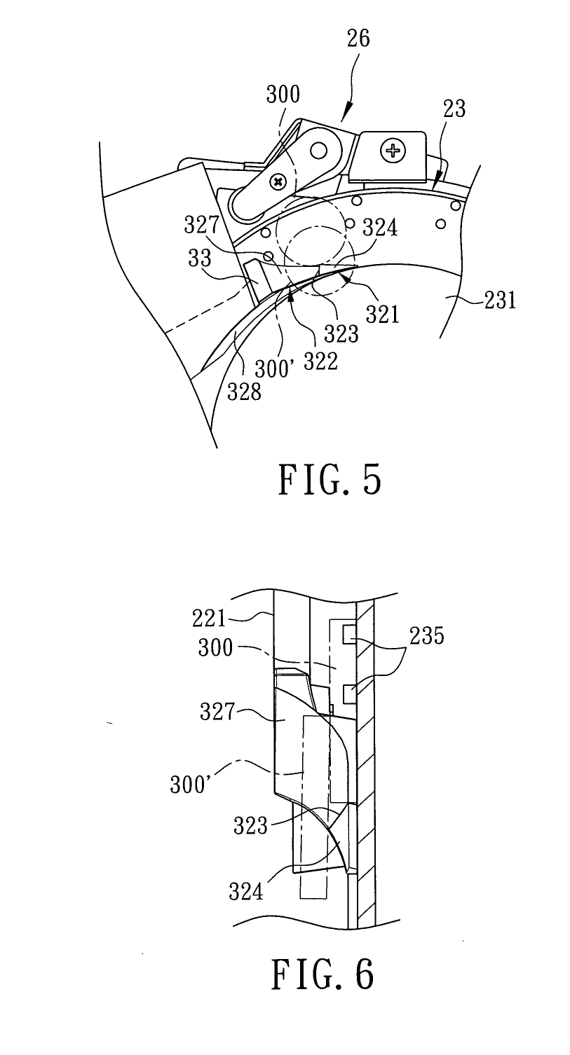

FIG. 5 and FIG. 6 illustrate a first situation of separation of a pair of stacked coins 300, 300′ by the coin-guiding plate 3, where the coin 300, referred to as the first coin 300, is received in a corresponding one of the regions 234, and the coin 300′, referred to as the second coin 300′, is stacked on the first coin 300. With further reference to FIG. 2, in the first situation, as the pair of stacked coins 300, 300′ passes over the guiding segment 32 of the coin-guiding plate 3 during movement in the first direction (B) along with the rotation of the rotary plate 23, the pair of stacked coins 300, 300′ experiences a shake-resulting drop, which eventually leads to separation of the pair of stacked coins 300, 300′, due to the presence of the step 323 at the junction of the first and second guiding portions 321, 322 of the guiding segment 32. In particular, the second coin 300′ slides along the first and second inclined surfaces 324, 327 toward the central plate portion 231 of the rotary plate 23 because the first and second inclined surfaces 324, 327 incline toward the axis of the rotary plate 23. On the other hand, the first coin 300 continues to move along with rotation of the rotary plate 23 in the first direction (B), and passes through the gap formed between the blocking member 33 of the coin-guiding plate 3 and the groove bottom of the groove 232 to exit the housing 22 via the coin exit member 221. Eventually, the exit of the first coin 300 is taken as one coin count by the coin-counting unit 26 of the coin counter 2.

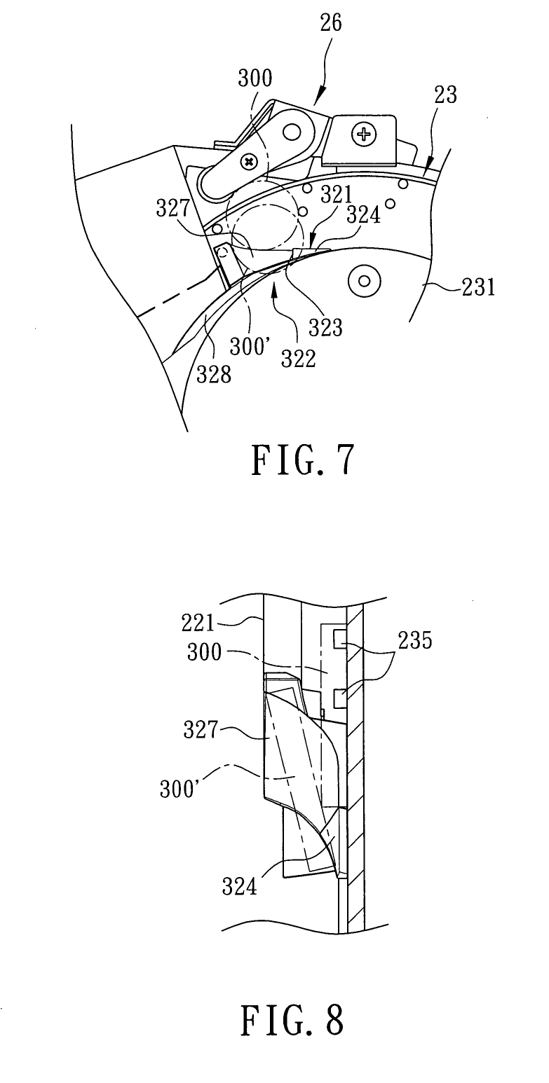

FIG. 7 and FIG. 8 illustrate a second situation of the separation of the pair of stacked coins 300, 300′ by the coin-guiding plate 3. With further reference to FIG. 2, in the second situation, when the shake-resulting drop experienced by the pair of stacked coins 300, 300′ due to the step 323 at the junction of the first and second guiding portions 321, 322 as the pair of stacked coins 300, 300′ passes over the guiding segment 32 of the coin-guiding plate 3 during movement in the first direction (B) along with the rotation of the rotary plate 23 is not sufficient to result in the separation of the pair of stacked coins 300, 300′, the pair of stacked coins 300, 300′ continues to move together toward the blocking member 33 of the coin-guiding plate 3 along with the rotation of the rotary plate 23. Since the gap formed between the blocking member 33 and the groove bottom of the groove 232 is smaller than the combined thickness of two coins 300, i.e., the combined thickness of the pair of stacked coins 300, 300′, so that at most one coin 300 is allowed to pass therethrough, while the first coin 300 passes through the gap, the second coin 300′ is forced to slide along the second inclined surface 327 and eventually move toward the central plate portion 231 of the rotary plate 23. Similar to the first situation, the first coin 300 exits the housing 22 via the coin exit member 221, and the exit of the first coin 300 is taken as one coin count by the coin-counting unit 26 of the coin counter 2.

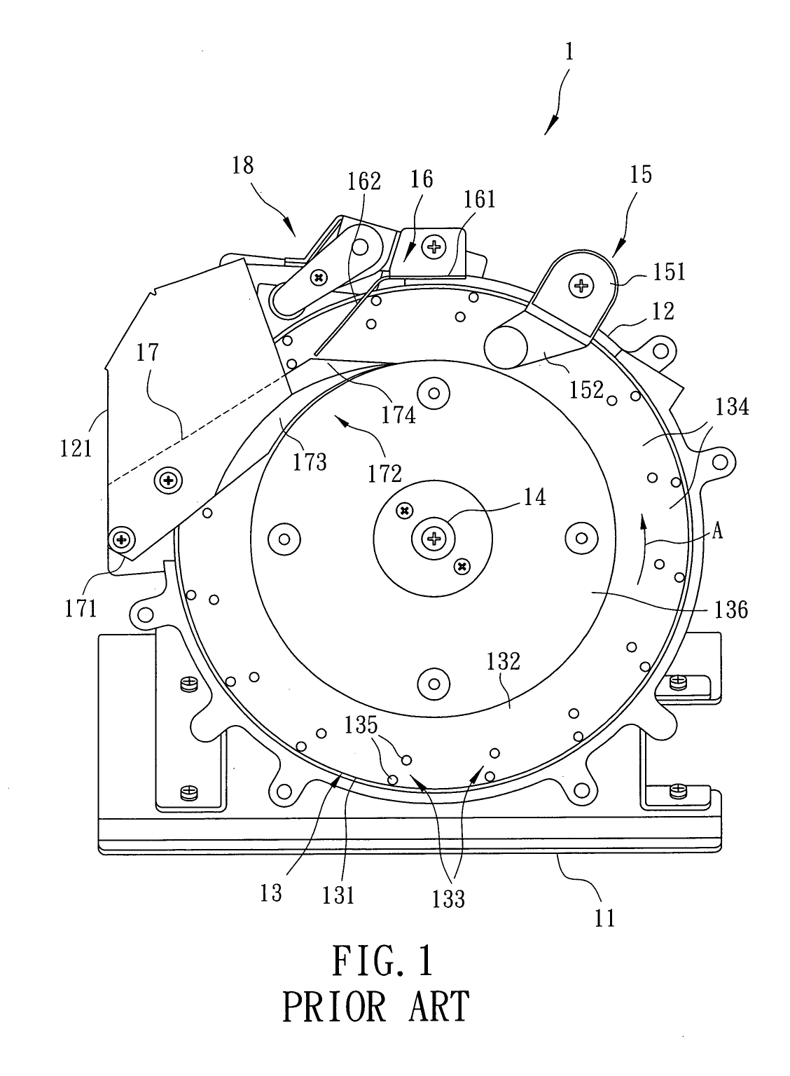

In sum, the coin-guiding plate 3 according to the present invention utilizes the step 323 formed at the junction of the first and second guiding portions 321, 322 of the guiding segment 32 to create the shake-resulting drop to be experienced by a pair of stacked coins 300, 300′ with one of which received in a corresponding one of the regions 234 as the pair of stacked coins 300, 300′ passes over the guiding segment 32 so as to separate the stacked coins 300, 300′. The coin-guiding plate 3 is further provided with the blocking member 33 and the curved second inclined surface 327 for forcing the second coin 300′ (refer to FIG. 5 and FIG. 7) (i.e., the coin stacked on the first coin 300) to slide along the curve of the second inclined surface 327 and eventually move toward the central plate portion 231 of the rotary plate 23. In addition, the blocking member 33 is adapted to form the gap with the groove bottom of the groove 232 so that at most one coin 300 can pass through the gap to exit the housing 22 via the coin exit member 221. Therefore, the coin-guiding plate 3 according to the present invention effectively replaces the first and second push members 15, 16 (as shown in FIG. 1) of the prior art. As compared to the first and second push members 15, 16 of the prior art, the coin-guiding plate 3 is further advantageous in that since the coin-guiding plate 3 is an integrally formed piece made of rigid metal, the coin-guiding plate 3 does not involve any springing action as with the prior art, and is therefore resistant to deformation. Consequently, the coin-guiding plate 3 according to the present invention, when incorporated into a coin counter 2, ensures precise counting of the coins 300, in addition to preventing stacked coins 300, 300′ from damaging the coin exit member 221 of the housing 22 of the coin counter 2, thereby extending the lifetime of the coin counter 2.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A coin-guiding plate adapted for use in a coin counter that includes a housing provided with a coin exit member, and a rotary plate mounted rotatably in the housing and formed with a central plate portion and a groove having a groove bottom and surrounding the central plate portion for moving coins received in the groove in a first direction, said coin-guiding plate comprising:
a fixing segment;
a guiding segment extending from said fixing segment in a second direction opposite to the first direction,
said guiding segment having first and second sides opposite to each other in a third direction, and including a first guiding portion and a second guiding portion connected between said first guiding portion and said fixing segment,
said second guiding portion being recessed relative to said first guiding portion at said second side of said guiding segment so as to form a step at a junction of said first and second guiding portions,
said first guiding portion having a pointed tip opposite to said second guiding portion; and
a blocking member formed at a junction of said fixing segment and said second guiding portion;
said fixing segment being adapted to be fixed to the housing of the coin counter adjacent to the coin exit member such that said guiding segment extends into the groove of the rotary plate, and such that said first and second sides of said guiding segment respectively face toward and away from the central plate portion of the rotary plate,
said blocking member being adapted to form a gap with the groove bottom of the groove when said fixing segment is fixed to the housing of the coin counter, said gap having a size greater than a thickness of a coin and smaller than a combined thickness of two coins so as to allow at most one coin to pass through said gap.

2. The coin-guiding plate as claimed in claim 1, wherein said first guiding portion further has a first inclined surface that extends from said pointed tip to said junction of said first and second guiding portions at said second side of said guiding segment, and that inclines toward an axis of the rotary plate when said fixing segment is fixed to the housing of the coin counter.

3. The coin-guiding plate as claimed in claim 2, wherein said second guiding portion further has a second inclined surface that extends from said junction of said first and second guiding portions to said blocking member, and that inclines toward the axis of the rotary plate when said fixing segment is fixed to the housing of the coin counter.

4. The coin-guiding plate as claimed in claim 3, wherein said second inclined surface is a curved surface.

5. The coin-guiding plate as claimed in claim 1, wherein said first side of said guiding segment is a concave side.

6. The coin-guiding plate as claimed in claim 1, wherein said coin-guiding plate is an integrally formed piece made of rigid metal.

7. The coin-guiding plate as claimed in claim 6, wherein the rigid metal is steel.
